(19) United States
(12) Patent Application Publication
(10) Pub. No.: US 2008/0134157 A1
(43) Pub. Date: Jun. 5, 2008

(54) Approach and System for Process Execution of an Integrated Telecom Platform

(75) Inventor: Yongkun Liao, Shenzhen City (CN)

Correspondence Address: ERIC CHAN, 42 PIN OAKS DRIVE, PHOENIXVILLE, PA, 19460, US

(73) Assignee: Shenzhen Donjin Communication Tech Co., Ltd, Shenzhen City (CN)

(21) Appl. No.: 11/718,798

(22) PCT Filed: Jun. 9, 2006
(86) PCT No.: PCT/CN06/01273

§ 371 Date: May 7, 2007

(30) Foreign Application Priority Data
Oct. 28, 2005 (CN) 200510100897.6

(51) Int. Cl. G06F 9/45

(52) U.S. Cl. 717/140

(57) ABSTRACT

An approach for process execution for an integrated telecom platform including the following steps: (a) The process execution module loads the process dynamic link library according to the set process parameters; (b) process execution module dispatches process creating function to create the corresponding process data structure duplicate according to the set resource channel number; (c) use the event information to activate the process data structure duplicate to a process, then the activated process will call the process running function or system functional function to process the event packets of resource channels bound to it. This invention also offers a process execution system for an integrated telecom platform. This invention makes the system operates at a higher efficiency by directly dispatching the execution process through the process execution modules.

### BACKGROUND OF THE INVENTION

The present invention generally relates to the field of telecom and more particularly to an approach and system of process execution of integrated telecom platform.

As the development of telecom services, the focus has been shifted from voice services to value-added services for a better revenue. The need towards value-added services naturally generates the need for platform equipment of such value-added services. However, the value-added services have the following features: (1) the service need is usually very urgent, demanding the service carrier/manufacturer to release the equipment quickly and if the service is well accepted by people then the system needs to be expanded for a big capacity; (2) the needs for value-added services keep changing rapidly: typically a kind of service will be replaced by another in one or two years, therefore, the equipment cost (both hardware and software) is also a critical factor determining whether the service will be popular or not.

Considering the aforesaid features of the value-added service equipment, the current computer telephony integration (CTI) system has three major defects: first, the complexity of API in current system makes the equipment R&D cycle very long and the soft cost can be very high; second, the structure design is not so good, making the “hard” unit cost is quite high and the “hard” cost of the whole equipment is high; third, the single-board processing density and the cascade expandability can not satisfy the need for high density and expandability of some systems.

FIG. 1 shows the structure of the CTI mid-ware and flow chart input tool for the current ITP system. While running, mid-ware 12 translates the flow chart input by the flow chart input tool and dispatches the function in the corresponding API function library for execution of CPU module 14 to realize the resource management and dispatch between the DSP signal processing modules 15. The execution efficiency will be greatly affected since such a mid-ware 12 needs conversion by multiple layers of software. Furthermore, the mid-ware is not so flexible for application since it adopts the execution way of translation for flow chart input because the mid-ware can only translate and execute some functions related to the application instead of all the API integrated functions. Therefore, the current mid-ware can adapt only some specific applications instead of all kinds of applications.

### BRIEF SUMMARY OF THE INVENTION

The invention aims to provide an approach and system for the process execution of an integrated telecom platform to overcome the defects of the current systems in terms of low resource management and low dispatching efficiency.

The technical solution of the invention to solve the technical issue concerned is: developing a process execution approach, including the following steps:

(a) The process execution module loads the process dynamic link library according to the set process parameters;
(b) process execution module dispatches process creating function to create the corresponding process data structure duplicate according to the set resource channel number;
(c) the process data structure duplicate will be activated through event information, and the activated process will dispatch corresponding process operation function or systematic functional function to process event packets of resource channels bound with them.

In accordance with a feature of the invention, the Step (a) includes the follows:

(a1) the process definition input through flow chart input tools is converted into source code;
(a2) the said source code is then compiled into the process dynamic link library.

In accordance with a feature of the invention, the Step (a) includes the follows.

One or more of process names, process paths, number of process channels, process binding, process load/start/stop/unload control, and status monitoring.

In accordance with a further feature of the invention, the process operation function of Step (c) includes the follows: one or more of idle resource channel acquisition/idle process channel, process binding/unbinding, display status information, timer.

In accordance with additional feature of the invention, the process structure data duplicate of Step (b) includes the follows: process data structure and process code.

In accordance with the feature of the invention, the process data structure includes process status, process mark, pointer to binding events, pointer to systematic function array.

In accordance with the feature of the invention, the process code includes process creating function used to allocate a process data structure space and initialization variable, process close function used to release process data structure space pointing by handle according to the input process data structure handle, and process operation function running on the status drive according to input process data structure handle.

In accordance with yet an added feature of the invention, the system includes flow chart input tool and process execution module. Wherein the flow chart input tool connects the process execution modules, process execution module connects multiple digital signal processing modules. The flow chart input tool converts the input user setting to code executable for process execution module and send to the said process execution module. After the process execution modules are loaded to dynamic link library, the process structure data duplicates are created.

In accordance with yet an added feature of the invention, the process structure data duplicate includes process data structure and process code.

In accordance with yet an added feature of the invention, the process data structure includes process status, process mark, pointer to binding events, and pointer to systematic function array. The said process code includes process creating function used to allocate a process data structure space and initialization variable, process close function used to release process data structure space pointing by handle according to the input process data structure handle, and process operation function running on the status drive according to input process data structure handle.

The invention makes the system higher operation efficiency by using the process execution module to dispatch directly to the execution process.

### BRIEF DESCRIPTION OF THE DRAWINGS

Illustrations and examples are provided herein for further explanation on the Invention. The illustrations cover:

FIG. 1 conceptually illustrates the structures of the CTI software middleware and the flow chart input tool of the present IPT system;

FIG. 2 represents the architecture of the system applying the module configuration management approach in integrated telecom platform of this invention;

FIG. 3 conceptually depicts the structure of the digital signal processing module of FIG. 2;

FIG. 4 represents the modules of the system of FIG. 2;

FIG. 5 represents the digital signal processing module of FIG. 4;

FIG. 6 conceptually illustrates the process execution module of FIG. 4;

FIG. 7 represents the flow chart of the module configuration management approach in integrated telecom platform of this invention.

### DETAILED DESCRIPTION OF THE INVENTION

FIG. 1 conceptually illustrates the structures of the CTI software middleware and the flow chart input tool of the present IPT system. While running, software middleware 12 explains the flow chart from flow chart input tool 11 and transfers the corresponding functions from API function library 13, and then carried out by embedded CPU module 14. By this means, to realize resource management and dispatching of DSP signal processing module 15. The execution efficiency middleware 12 will be greatly influenced because multi-layer software conversion process is required during processing. Meanwhile, because it inputs the flow chart by way of explanation execution, it undoubtedly limit the adaptability software middleware, and middleware is unable to completely explain all API combined functions and can only make the explanation to some relevant application functions. Therefore, the present software can only be suitable for some particular application, not suitable for all applications.

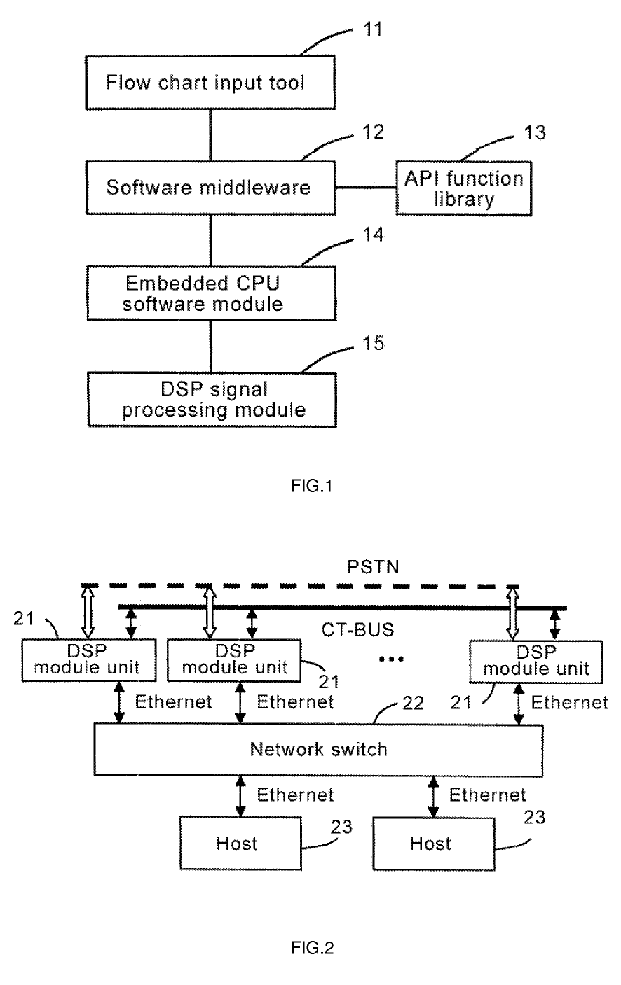

FIG. 2 represents the architecture of the system applying the module configuration management approach in integrated telecom platform of this invention. In this example, the system includes one or more Digital Signal Processing (DSP) Module 21—the minimum hardware unit processing real-time signals (e.g. voice signal). Different DSP modules 21 are independent from each other. DSP modules 21 are connected via CT-BUS for communication between each other, and each of them is also connected to PSTN via communication.

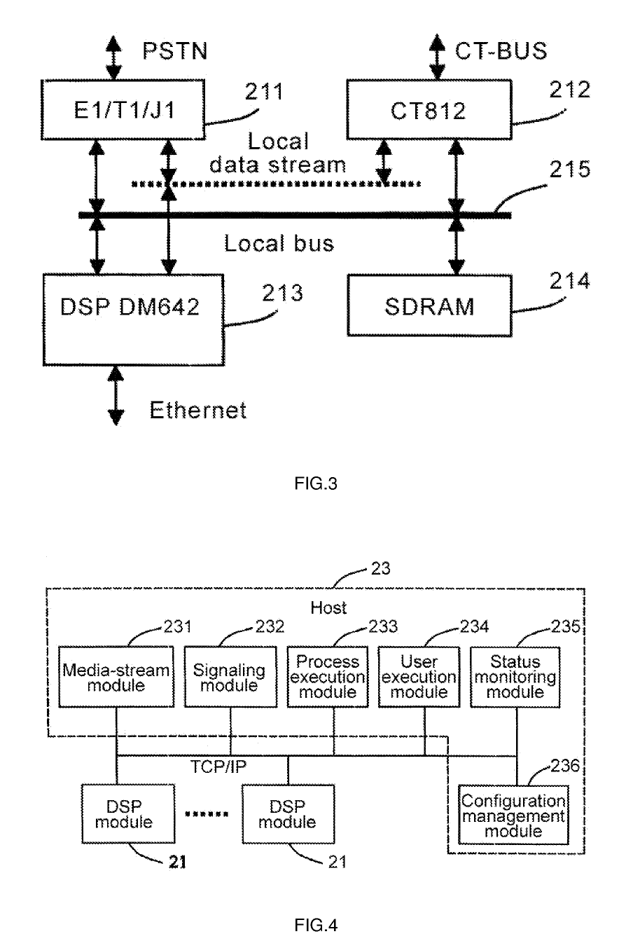

Each DSP Module 21 is also connected to the Network Switch 12 via Ethernet (e.g. twisted pair line), and the Network Switch 22 is connected to one or more Host 23 via Ethernet. Each Host 23 includes one or more functional modules (not indicated in FIG. 2) for such functions as recording and playback of data stream, connection setting and data frame monitoring (refer to FIG. 3 for detailed descriptions for the functional modules). The Network Switch 22 can be used for transmission of Ethernet protocol frames.

FIG. 3 represents the structure of the Digital Signal Processing Module 21 in FIG. 2. In this case, the DSP Module 11 simultaneously completes processing of voice signals and signalings of layer 2, including E1/T1/J1 PSTN Interface 211, CT812 Chip 212, DM642 Chip 213 and SDRAM 214. E1/T1/J1 PSTN Interface 211, CT812 Chip 212, DS Chip 213 and SDRAM 214 are connected to local bus 215 respectively. DSP Module 11 is connected to PSTN via E1/T1/J1 PSTN Interface 211 and to other DSP modules via CT812 Interface 212. DSP Chip 212 adopts high-performance TMS320DM642 and provides over 4800 MIPS processing capabilities. A single chip can process all signalings and voice signals from four E1 on a real-time basis. In this case, each DSP Module 21 has an exclusive IP address.

FIG. 4 represents all the modules of the system in FIG. 2. Host 23 includes multiple functional modules, such as Media Streaming Module 231, Signaling Module 232, Process Execution Module 233, User Module 234, Status Monitoring Module 235 and Configuration Management Module 236, which are based on certain hardware to provide specific functions. Each functional module is independent from each other. They can be located on the same Host 23 or distributed on different interconnected hosts. Each functional module has the same IP address as the host on which it is installed. If a host has more than one functional module on it, such modules have the same IP address and different configuration management sides. Each functional module includes a network client side submodule and network service side submodule (not indicated in the figure) for communication with other modules.

Among the aforesaid functional modules, except the configuration management module 236, every other functional module has a standard program framework which is unrelated to its function. This will ensure that the integrated telecom service system has the best universality, which meets the actual operational needs without any program amendment and only change of the external definition files and the process definition are needed if necessary. The standard framework includes: inter-module communication mode; standard data structure and standard program process.

TCP/IP protocol is used in an embodiment for the inter-module communication. Each ITP module is connected with the TCP terminal service submodule of the related inferior module through TCP terminal service, and is connected with the TCP terminal service of the related superior module by offering the TCP terminal service submodule.

In one embodiment of the present invention, the standard data structure includes a connection list used for managing the status of connecting with the other related modules. The connection lists of all modules can be divided into three categories: a. connected to the configuration management module (one); b. connected to inferior module (one or more); c. connected to superior module (one or more). When the module is just started, the connection list will be cleared which indicates that there is no effective connection. During operation whenever it is connected with another related module the corresponding item on the connection list is set to an effective value. When the connection is removed the corresponding item will be set to 0.

In one embodiment of the present invention, the standard program process includes: (1) Load the configuration information (if necessary) after starting the module and process it, then initialize the data. (2) Set parameters of the TCP terminal service submodule, and monitor the access of other modules' terminal service. (3) Check if there is connection of any legal terminal service with the current module's terminal service submodule. If there is such connection, put it into the connection list of current module. (4) Check if there is any configuration management packet from the configuration management module received. Go to step (5) if there is. Clear the corresponding item on the connection list and go to step (6) if disconnected. (5) Process the configuration management packet and go to step (4). (6) Check and process the communication packets received from inferior modules. (7) Process the communication packets to be sent to the inferior module. (8) Check and process the communication packets received from the superior module and go to step (3).

The media stream module 231 is used for recording and playing of the media data based on the digital signal processing module 21. The signaling module 132 is used for processing the signaling protocol of third level or above of No. 7 signaling and Q.931 signaling protocol of digital No. 1 signaling. The process execution module 133 is used for realizing the controlling of system working process and fulfilling the service demand of CTI. The user module 234 is used for processing of the applications unrelated to CTI functions, such as database processing. This user module 234 is programmed by the user. And it is not a necessary module in this case. The aforesaid media stream module 231, signaling module 232, process execution module 233 and user module 234 are all in a waiting status after system started. One of ports at the network terminal service submodule monitors the control information from the configuration management module 136, and executes certain operations according to the control information received.

The configuration management module 236 is the core of the integrated telecom service system. Each functional module operates according to the control instructions of the configuration management module 136. In this embodiment of the present invention, each digital signal processing module 21 has a sole MAC address. The configuration management module 236 will bind such MAC addresses to the IP address set by the configuration management module. Besides, the configuration management module 236 will acquire the IP addresses and the configuration management ports of the functional modules of the access system, based on which the configuration management module 136 will set up connections and configure the modules. Then it can pass the address information to the related modules and send out the control instructions to start such modules to a normal working process. During the normal working process the configuration management module will carry out the functions of monitoring the module operation status, stop/start and add/delete modules etc.

In the shown example, the media stream modules 231 can be related to the digital signal processing module 21 and the signaling modules 132 can be related to the digital signal processing modules 21. The process execution module can be related to digital signal processing module 21, media stream module 231 and signaling module 232. The information is transmitted among related modules through Ethernet protocol frames, thus services of the integrated telecom service system are realized.

The configuration management module 236 can control the functional modules to go into different working status, including: disconnected; connected; operating normally, etc. Besides controlling and displaying the working status of each module, the configuration management module 136 shall regularly monitor the working status of operating functional modules in order to find out any failed module.

The status monitoring module 235 is used for monitoring the content of communication packets among other modules which can be realized though the following approach: the status monitoring module 235 sends a monitoring request to the configuration management module 236 which will then pass the request to the relevant functional modules. Then the corresponding functional modules will transmit a copy of the communication packets to the status monitoring module 235.

The FIG. 5 shows the digital signal processing module 21 in FIG. 4. Digital signal processing module 21 functionally consists of the voice processing submodule 216 and the signaling processing submodule 217. The voice processing submodule 216 is used for processing all voice signals. The signaling processing submodule 217 includes a four-channel signaling processing unit and a receiving/transmitting frame format controlling and monitoring unit. Three options are available for setting the working mode of each signaling processing unit: SS1, DSS1 and SS7. When SS1 mode is set each unit will process 30 channels of DL signalings for one E1; when DSS1 mode is selected, each unit will process one Q.921 link; for SS7, each unit will process one MTP2 link. The frame format controlling and monitoring unit will fulfill the controlling and monitoring over receiving/transmitting frame format of four E1s and the alarming processing, etc.

After data from voice processing sub-module 216 and signaling processing submodule 217 have been encapsulated as Ethernet protocol frames by Master Scheduler 218, such Ethernet protocol frames are transmitted to the functional module for further processing, or, after master scheduler 218 has processed the frames from functional module or configuration management module 236, the frames are transmitted to voice processing submodule 216 or signaling processing submodule 217 for processing.

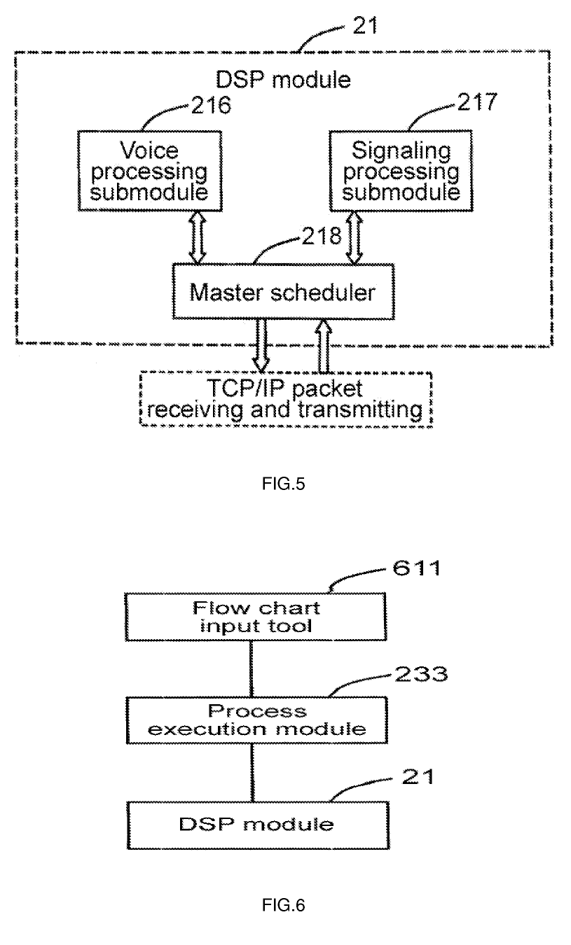

The FIG. 6 conceptually depicts the process execution module 233 of FIG. 4, which is used to unified management of the all function resource offered by inferior module (such as DSP 21 module) and process resource loaded in this module and carry on effective allocation management and dispatching.

As shown in the figure, the process execution module 233 connects flow chart input tool 611 and multiple DSP modules 21 (only show one in the figure) separately. The flow chart input tool 233 is used to input process parameter, and users can define user's variable in the graphical interface flow chart through flow chart input tool 233. User variables include normal variable, resource handle type, process handle type, include specifically: process setting (name, route, channels, binding), process load/start/stop/unload control, status monitoring (related module status, resource channels status, process channel status). flow chart input tool 611 still keep the file as an intact process save file based on the flow chart input process parameters, then process save file is converted to standard code (such as C code, etc.), and compiles as executable codes by process execution module 233.

Process execution module 233 executes the executable code created by the aforesaid flow chart input tool 611 and load the dynamic link library according to the setting as well as transfer process creating function to create corresponding quantity of process data structure duplicate according to the setting channels. Operation of all process are activated and driven by particular event information. Any process to certain resource channel can be set as binding, and when the event packets reach the resource channel, it will be transacted by transferring the corresponding process operation function or systematic functional function. And the process can also be bound to certain special events. For instance, process execution module 233 can offer the regular events to activate some process.

In the embodiment of the present invention, the process refers to the program code according with the standard frame of the process and the program code exists in the form of dynamic link library.

The process standard frame includes two parts: i.e. process data structure and process code. Wherein process data structure includes the structure head and additional data structure. Structural head is use to transmit information between process execution module 233 and process program. The additional data structure is the saved variable data for operation defined in the process. Process data structure head includes process status, process mark, pointer to binding event packets, and pointer to the systematic function array. Process status is used to control operation of process program. The procedure mark is used to mark several duplicates of the same process and can be freely configured by users so as to use for applying for the index of resources. The pointer to binding event packets transfers the event packets to the process program. The pointer to systematic function array make the process program can transfer systematic function offered by process execution module.

The process code includes three functions: process creation, process closing and process operation. Wherein process creation function finishes assigning a process data structure space and initializes relevant variables, etc, and the function returns and points to the handle to assign process data structure. The input parameter of process closing function is the handle of process data structure, and function finishes releasing the structural space of process data pointed by the input handle. The input parameters of process operation function is the structural handle of process data, and function would run in the form of status driving, i.e. transfer and execute present status to the code of next status each time.

In the embodiment of the present invention, the process execution module 233 offers several systematic function functions for process program transferring, and enables the process program to get the function of assigning and transferring of all resources.

Certainly, these systematic functional functions can be also used by process execution module 233 by itself. These systematic functional functions include: the function sending communication packets to other modules, the function to search for idle resource channel, the function to release occupancy resources, the function to obtain idle process, the function to release occupancy process and the function to bind process channel and resource channel, the function to unbind process channel and resource channel, the function to reveal the process channel information, the function to configure a timer, the function to terminate a timer ahead of time, etc.

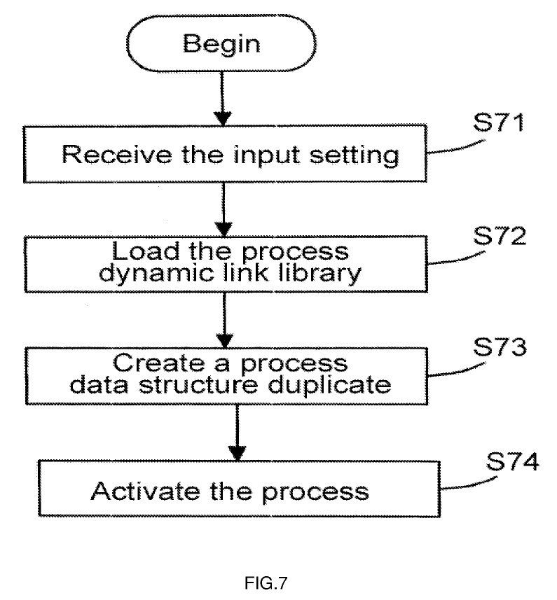

FIG. 7 represents the flow chart of the module configuration management approach in integrated telecom platform of this invention. First, flow chart input tool 611 receives the input user setting parameters, and saves the graphic interface flow chart as an intact process save file, then compiles the aforesaid process save file as executable code (step s71).

Process execution module 233 executes the compiled code, load them to process dynamic link library according to the setting process parameters (step s72). Process execution module 233 transfer process creation function to create corresponding process data structure duplicate according to the setting resource channel (step S73).

The aforesaid process data structure duplicate is activated to process, and the activated process transfer corresponding process operation function to transact event packets of resource channel bound with them (step S74).

The above paragraphs are just some examples of practice of the Invention instead of any limitation in any form to the Invention. Any simple modification, amendment, revision, equivalent change or embellishment with the technical essence of the Invention falls into the technical solution and claims of the Invention.

What is claimed is:

1. An approach for process execution for an integrated telecom platform, including the following steps:
(a) The process execution module loads the process dynamic link library according to the set process parameters;
(b) process execution module dispatches the process creating function to create corresponding process data structure duplicate according to the setting resource channel number;
(c) use the event information to activate the process data structure duplicate to a process, then the activated process will call the process running function or system functional function to process the event packets of resource channels bound to them.

2. The approach of claim 1 wherein the Step (a) includes the following steps:
(a1) The process definition input through flow chart input tools is converted into source code;
(a2) The said source code is then compiled into the process dynamic link library.

3. The approach of claim 1 wherein the Step (a) includes one or more of process name, process path, number of process channels, process binding, process load/start/stop/unload control, and monitoring over statuses.

4. The approach of claim 1 wherein the systematic functional function of Step (c) includes one or more of idle resource channel acquisition/idle process channel, process binding/unbinding, display status information, timer.

5. The approach of claim 1 wherein the process structure data duplicate of Step (b) includes the process data structure and the process code.

6. The approach of claim 5 wherein the process data structure includes the process status, process mark, pointer to binding events, pointer to systematic function array.

7. The approach of claim 5 wherein the process code includes the process creating function used to allocate a process data structure space and initialization variable, process close function used to release process data structure space pointing by handle according to the input process data structure handle, and process operation function running on the status drive according to input process data structure handle.

8. A process execution system for an integrated telecom platform, which includes the flow chart input tool and process execution module. Wherein the flow chart input tool connects the process execution modules, process execution module connects multiple digital signal processing modules. The flow chart input tool converts the input user setting to code executable for process execution module and send to the said process execution module. After the process execution modules are loaded to dynamic link library, the process structure data duplicates are created.

9. The approach of claim 8 wherein the process structure data duplicate includes the process data structure and process code.

10. The approach of claim 9 wherein the process data structure covers the process status, process mark, pointer to binding events, pointer to systematic function array. The said process code includes process creating function used to allocate a process data structure space and initialization variable, process close function used to release process data structure space pointing by handle according to the input process data structure handle, and process operation function running on the status drive according to input process data structure handle.
